(19) United States
(12) Patent Application Publication
(10) Pub. No.: US 2010/0309519 A1
(43) Pub. Date: Dec. 9, 2010

(54) Printer driver program product and information processing apparatus

(75) Inventor: Yoshito Nishihara, Chiba (JP)

Correspondence Address: Harness, Dickey & Pierce P.L.C., P.O. Box 8910, Reston, VA, 20195, US

(73) Assignee: Ricoh Company, Limited

(21) Appl. No.: 12/801,143

(22) Filed: May 25, 2010

(30) Foreign Application Priority Data
Jun. 5, 2009 (JP) 2009-136540

(51) Int. Cl. G06F 15/00

(52) U.S. Cl. 358/1.15

(57) ABSTRACT

Setting information of a printer driver and setting information of plug-in software added to the printer driver are stored in different folders from each other, and managed independently of each other. At the time of using a function of the plug-in, the printer driver merges the setting information of the printer driver with the setting information of the plug-in, and controls the print setting or a printer device by using the merged setting information. As the setting information of the printer driver and the setting information of the plug-in are stored in the different folders, when the plug-in is removed, as for the setting information, it is only necessary to delete the setting information of the plug-in to be removed; thus, it is easy to remove the plug-in.

### CROSS-REFERENCE TO RELATED APPLICATIONS

The present application claims priority to and incorporates by reference the entire contents of Japanese Patent Application No. 2009-136540 filed in Japan on Jun. 5, 2009.

### BACKGROUND OF THE INVENTION

1. Field of the Invention

The present invention relates to a printer driver program product and an information processing apparatus enabling the easy deletion of a function added to a printer driver.

2. Description of the Related Art

In recent years, there has been a growing need for the sale of a customized printer device that use only necessary functions. In response to this need, there has been promoted the development of a printer device capable of having a function added as a plug-in to original functions of the printer device. In this case, to make the function added to the printer device available from a computer, a printer driver for controlling the printer device also requires a means of having its function extended. Similarly, there is a need for a functional extension of printer driver alone.

In a functional extension with respect to a printer driver, there is a way of newly generating a functionally-extended printer driver by recompiling an original printer driver. However, in this case, the functionally-extended printer driver needs to be reinstalled on a user's computer, which results in a decrease in user-friendliness.

Consequently, there is proposed a technique for a functional extension of a printer driver by the use of a plug-in mechanism. A plug-in is a mechanism for removably adding an additional function to a predetermined basic program. For example, by installing plug-in software for adding a predetermined function to application software, a function that is not included in standard functions of the application software or a more sophisticated function can be used. By the use of a plug-in mechanism, a new function can be added to the printer driver without recompiling or reinstalling of the printer driver.

Japanese Patent No. 3745344 discloses a technology in which a means for detecting an addition of a plug-in program is given to a device driver, and an event notification from an operating system is transferred to the plug-in program of which the addition is detected. According to the technology disclosed in Japanese Patent No. 3745344, a functional extension can be dynamically made with respect to the device driver without recompiling of the device driver.

An example of a conventional method for adding plug-in software to a printer driver is schematically explained here. The printer driver includes a core module for performing basic functions of the printer driver, such as print setting and drawing, and a setting information unit in which setting information with respect to the core module is written. The setting information includes, for example, screen-layout information for providing a user interface for print settings, function information on a function used for drawing, and setting-saving-destination information on a destination for saving setting information.

When a function addition to the printer driver is made by the use of plug-in software, a plug-in module unit is added to the configuration of the printer driver composed of the core module and the setting information unit. Like the printer driver described above, the added plug-in software also includes, as setting information, screen-layout information, function information, and setting-saving-destination information.

In this conventional method, the screen-layout information, the function information, and the setting-saving-destination information of the added plug-in software are appended to the screen-layout information, the function information, and the setting-saving-destination information of the printer driver, respectively. Consequently, when the function added as plug-in software is used, it is possible to call up the setting information of the plug-in software, i.e., the screen-layout information, the function information, and the setting-saving-destination information of the plug-in software.

However, in this conventional method, there is a problem in that it is difficult to uninstall the plug-in software once added.

Namely, to uninstall the added plug-in software, the setting information of the plug-in software to be uninstalled needs to be deleted from the information of the printer driver. However, in the conventional method, the setting information of the added plug-in software is appended to the setting information of the printer driver. Thus, when the plug-in software is uninstalled, it is difficult to delete the setting information of the plug-in software to be uninstalled from the setting information of the printer driver, and thus it is difficult to uninstall the plug-in software.

If it is not possible to uninstall the added plug-in software, the following problem occurs.

A functional extension is not always concluded within the printer driver only; when an extension is added to the printer device, the function of the printer driver may have to be extended to use the extension. For example, when an extension is newly added to the printer device, and the printer driver needs to transmit some kind of command to the printer device to use the extension, the printer driver also requires a corresponding functional extension.

In such a functional extension, when an extension is removed from the printer device, from the point of view of usability, it is preferable that an extension added to the printer driver in response to the extension is also removed from the printer driver. This is because, when a user causes the printer device to print out a text or the like from a computer, it is the printer driver that directly operates the printer device. Thus, if the extension corresponding to the extension removed from the printer device is still added to the printer driver, it is highly likely that the user mistakenly believes the extension removed from the printer device is still available.

Furthermore, in the above-mentioned technology disclosed in Japanese Patent No. 3745344, uninstalling the added plug-in program is not taken into consideration.

### SUMMARY OF THE INVENTION

It is an object of the present invention to at least partially solve the problems in the conventional technology.

According to an aspect of the present invention, there is provided a printer driver program product comprising a computer usable medium having computer readable program codes embodied in the medium that when executed causes a computer, which includes a storage unit storing therein first setting information for setting the operation of a basic function of a printer device and being capable of storing therein second setting information for setting the operation of an extension of extending the basic function independently of the first setting information, to execute reading the first setting information and the second setting information from the storage unit, merging the first setting information and the second setting information which are read at the reading, and controlling the printer device by using setting information which the first setting information and the second setting information are merged at the merging.

According to an aspect of the present invention, there is provided an information processing apparatus comprising a storage unit that stores therein first setting information for setting the operation of a basic function of a printer device, and is capable of storing therein second setting information for setting the operation of an extension of extending the basic function independently of the first setting information, a reading unit that reads the first setting information and the second setting information from the storage unit, a merging unit that merges the first setting information and the second setting information which are read by the reading unit, and a control unit that controls the printer device by using setting information which the first setting information and the second setting information are merged by the merging unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram showing a configuration of an example of a system applicable to an embodiment of the present invention;

FIG. 2 is a block diagram showing a configuration of an example of a computer;

FIG. 3 is a functional block diagram of an example for explaining functions of the computer;

FIG. 4 is a schematic diagram showing a configuration of an example of a printer driver according to the embodiment of the present invention;

FIG. 5 is a schematic diagram showing an example of content of a screen-layout information file;

FIG. 6 is a schematic diagram showing an example of a print setting screen based on description of the screen-layout information file;

FIG. 7 is a schematic diagram showing an example of content of a function information file;

FIG. 8 is a schematic diagram showing an example of content of a setting-saving-destination information file;

FIG. 9 is a schematic diagram for explaining a management structure of an example of driver setting information according to the embodiment of the present invention;

FIG. 10 is a schematic diagram for explaining a management structure of an example of driver setting information according to the embodiment of the present invention;

FIG. 11 is a schematic diagram showing an example of a more concrete management structure of the driver setting information according to the embodiment of the present invention;

FIG. 12 is a flowchart illustrating a process of adding an example of a plug-in based on the management structure of the driver setting information according to the embodiment of the present invention;

FIG. 13 is a schematic diagram for explaining a process of reading driver setting information of the plug-in according to the embodiment of the present invention;

FIG. 14 is a flowchart illustrating a process of reading an example of driver setting information of a plug-in according to the present embodiment;

FIG. 15A is a schematic diagram showing an example of information written in a screen-layout information file of a Borderline plug-in;

FIG. 15B is a schematic diagram showing an example of information written in a screen-layout information file of a Stamp plug-in;

FIG. 16A is a schematic diagram showing an example of information written in a function information file of the Borderline plug-in;

FIG. 16B is a schematic diagram showing an example of information written in a function information file of the Stamp plug-in;

FIG. 17A is a schematic diagram showing an example of information written in a setting-saving-destination information file of the Borderline plug-in;

FIG. 17B is a schematic diagram showing an example of information written in a setting-saving-destination information file of the Stamp plug-in;

FIG. 18 is a schematic diagram showing an example where information written in a screen-layout information file of each plug-in is merged with information written in a screen-layout information file of a core module;

FIG. 19 is a schematic diagram showing an example where information written in a function information file of each plug-in is merged with information written in a function information file of the core module;

FIG. 20 is a schematic diagram showing an example where information written in a setting-saving-destination information file of each plug-in is merged with information written in a setting-saving-destination information file of the core module;

FIG. 21 is a schematic diagram showing an example where a plug-in is removed from the printer driver according to the embodiment of the present invention; and

FIG. 22 is a flowchart illustrating a process of deleting an example of a plug-in based on the management structure of the driver setting information according to the embodiment of the present invention.

### DETAILED DESCRIPTION OF THE PREFERRED EMBODIMENTS

Exemplary embodiments of a printer driver according to the present invention are explained in detail below with reference to the accompanying drawings. In the present invention, setting information of a printer driver and setting information of plug-in software added to the printer driver are managed independently of each other. At the time of using a function of the plug-in software, the printer driver merges the setting information of the printer driver with the setting information of the plug-in software, and performs print setting, control of a printer device, and the like by using the merged setting information.

Since the setting information of the printer driver and the setting information of the plug-in software are managed independently of each other, at the time of uninstalling the plug-in software, as for the setting information, it is a simple matter of deleting the setting information of the plug-in software, and the plug-in software can be easily uninstalled.

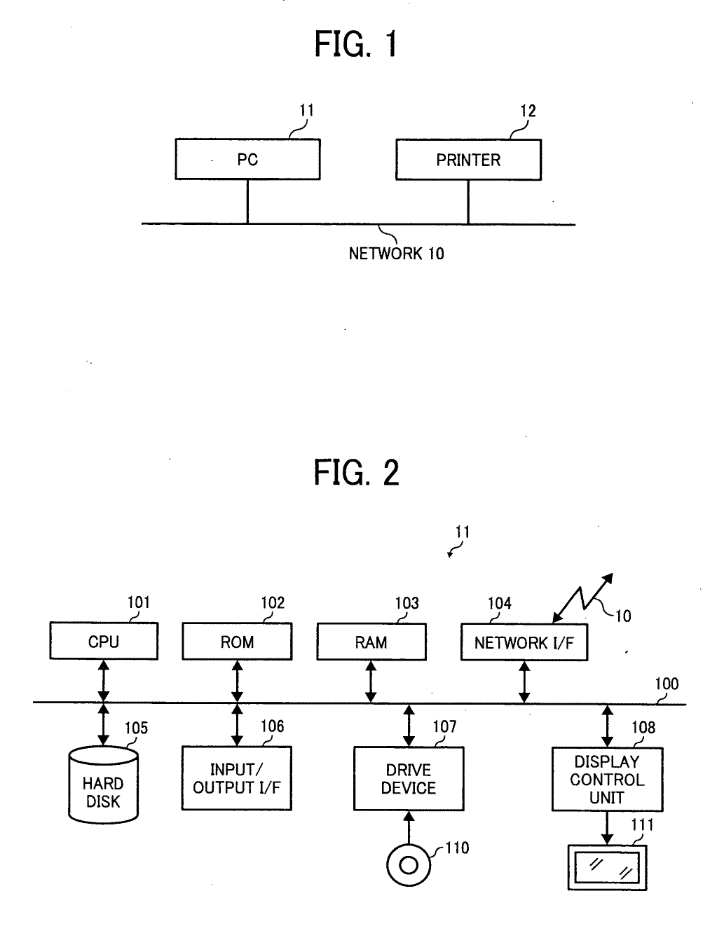

FIG. 1 shows a configuration of an example of a system applicable to an embodiment of the present invention. A computer 11 and a printer device 12 are connected to a network 10, such as a LAN (Local Area Network). A printer driver corresponding to the printer device 12 is installed on the computer 11, so the computer 11 can cause the printer device 12 to perform a printing operation via the network 10. Incidentally, the connection between the computer 11 and the printer device 12 is not limited to the network 10; alternatively, the computer 11 and the printer device 12 can be directly connected to each other by a USB (Universal Serial Bus) or the like.

FIG. 2 shows a configuration of an example of the computer 11 (the PC 11 in FIG. 1). In the computer 11, a CPU (Central Processing Unit) 101, a ROM (Read Only Memory) 102, a RAM (Random Access Memory) 103, a network I/F 104, a hard disk 105, an input/output I/F 106, a drive device 107 and a display control unit 108 are connected to a bus 100. These units connected to the bus 100 can exchange data with one another via the bus 100.

The CPU 101 controls the operation of the entire computer 11 by using the RAM 103 as a working memory in accordance with a program stored in the ROM 102 or the hard disk 105 in advance.

In the hard disk 105, a program for causing the above-mentioned CPU 101 to operate and various data are stored. As the program stored in the hard disk 105, there are an OS (Operating System) for performing the basic control of the operation of the computer 11, a printer driver for performing the management and control of the above-mentioned printer device 12, and the like. Furthermore, in the hard disk 105, data generated in the execution of the program by the CPU 101 can be temporarily stored. Incidentally, a nonvolatile semiconductor memory can be used as a substitute for the hard disk 105.

The input/output I/F 106 controls the data input/output with respect to the computer 11. For example, input devices, such as a keyboard and a mouse, are connected to the input/output I/F 106. A control signal depending on the user operation of these input devices is output from the input/output I/F 106, and supplied to the CPU 101 via the bus 100. The input/output I/F 106 can be compatible with a serial interface, such as the USB (Universal Serial Bus) or the IEEE (Institute of Electrical and Electronics Engineers) 1394.

The drive device 107 reads out data from a disk storage medium 110, such as a CD (Compact Disk) or a DVD (Digital Versatile Disk). However, the storage medium corresponding to the drive device 107 is not limited to this, and can be a nonvolatile semiconductor memory. The above-mentioned program for causing the CPU 101 to operate is stored in a storage medium, such as a CD, a DVD, or a nonvolatile semiconductor memory, and the storage medium is provided. The drive device 107 reads the program from the storage medium, and stores the read program in a certain area of the hard disk 105. A display control unit 108 is connected to a display 111, and converts a display control signal generated by the CPU 101 into a signal in a form that can be displayed on the display 111, and outputs the converted signal.

The network I/F 104 is compatible with, for example, the TCP/IP (Transmission Control Protocol/Internet Protocol), and can establish communication with the printer device 12 or other information equipment via the network 10. The above-mentioned program for causing the CPU 101 to operate can be provided from an external server device via the network 10, and received by the network I/F 104, and then stored in a certain area of the hard disk 105.

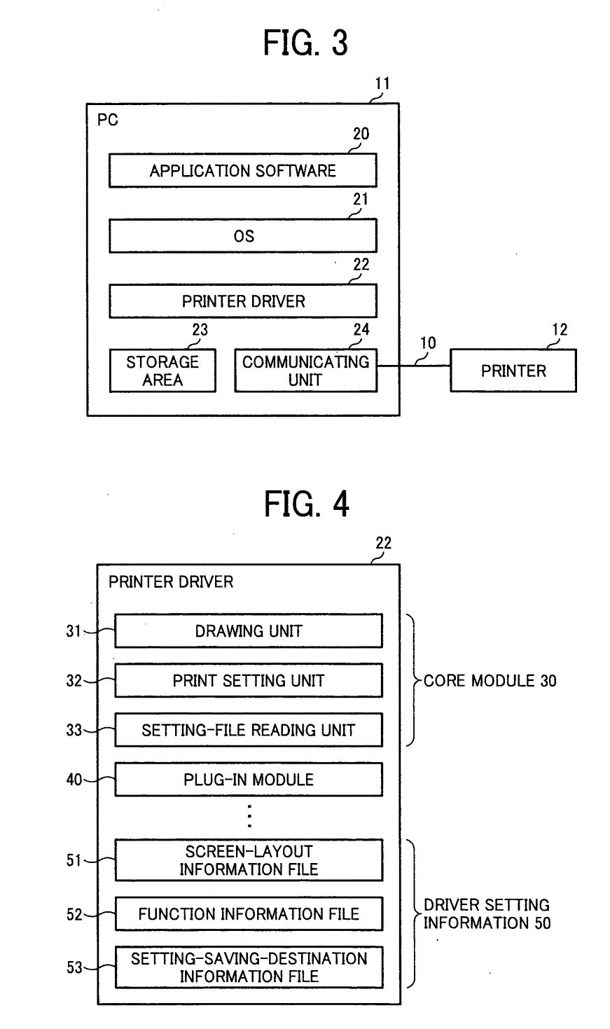

FIG. 3 is a functional block diagram of an example for explaining functions of the computer 11. The computer 11 is equipped with, as software, an OS (Operating System) 21, application software 20, and a printer driver 22. Furthermore, the computer 11 includes a communicating unit 24 for communicating with the printer device 12 via the network 10. The communicating unit 24 includes a communication device for physically performing communication with the printer device 12 via the network 10 and software for controlling the communication device. A storage area 23 is, for example, a certain area of the hard disk 105, and a file composing the printer driver 22 is stored in the storage area 23.

The application software 20 is, for example, word-processing software, spreadsheet software, or image forming software. The OS 21 includes a function of managing a file system and the storage area and the like, and controls the operation of the entire computer 11. The printer driver 22 controls the printer device 12 via the communicating unit 24.

As an example, to make the printer device 12 start a print job, the application software 20 calls the printer driver 22 corresponding to the printer device 12 via the OS 21, and supplies print setting information to the printer driver 22 as needed. Furthermore, the application software 20 supplies drawing data for performing the print job to the printer driver 22. The printer driver 22 creates drawing data in a form that can be interpreted by the printer device 12 on the basis of the print setting information and drawing data supplied from the application software 20. The printer driver 22 transmits the created drawing data to the printer device 12 via the communicating unit 24. The printer device 12 performs the print job in accordance with the received drawing data.

FIG. 4 shows a configuration of an example of the printer driver 22 according to the embodiment of the present invention. As shown in FIG. 4, the printer driver 22 includes a core module 30 and driver setting information 50. If plug-in software is added to the printer driver 22, the printer driver 22 further includes a plug-in module 40 composed of one file or a plurality of files making up the added plug-in software (hereinafter, abbreviated as “plug-in”). The printer driver 22 can have a plurality of plug-in modules 40.

Incidentally, it can be configured that the printer driver 22 adds a plug-in module 40 to a plug-in module unit provided in advance. In this case, it is thought that the plug-in module unit is composed of an archive file in which a predetermined folder or a plurality of files and a folder structure can be stored all together or the like.

The core module 30 is a module required for the printer driver 22 to operate as the printer driver 22, and composes the body unit of the printer driver 22. In the example shown in FIG. 4, the core module 30 includes a drawing unit 31, a print setting unit 32, and a setting-file reading unit 33. The drawing unit 31, the print setting unit 32, and the setting-file reading unit 33 are each composed of an executable file and a library file called up from the executable file to be used, or the like.

The drawing unit 31 creates drawing data in a form that can be interpreted by the printer device 12 on the basis of drawing data supplied from the application software 20 via the OS 21 and print setting information set by the print setting unit 32 to be described below, and transmits the created drawing data to the printer device 12.

The print setting unit 32 creates print setting information which is information reflected in a printing result. As the print setting information, there are the number of print copies, combined (N in 1) printing for printing a plurality of pages on a single sheet in combination, duplex printing for printing on both sides of a sheet, and the like. The print setting unit 32 generates display information for displaying a print setting screen, which is a GUI (Graphical User Interface) through which print setting information is input, on the display 111 in accordance with screen-layout information file 51 included in the driver setting information 50 to be described below. In accordance with the print setting screen displayed on the display 111 based on the display information, print setting information is input and set, for example, by the user operation.

The setting-file reading unit 33 performs a process according to the present embodiment, and has a function of reading driver setting information required for the operation of the printer driver 22. The setting-file reading unit 33, as will hereinafter be described in detail, reads the driver setting information 50 of the core module 30 and driver setting information of the plug-in module 40, which are managed independently of each other, and merges the two pieces of driver setting information to generate one piece of driver setting information.

The driver setting information 50 includes setting information required for the operation of the core module 30 in the printer driver 22. In other words, the driver setting information 50 is setting information used to set the operation of the core module 30. In the example shown in FIG. 4, the driver setting information 50 includes a screen-layout information file 51, a function information file 52, and a setting-saving-destination information file 53.

In the screen-layout information file 51, layout information of the print setting screen displayed by the print setting unit 32 described above is written. Namely, in the screen-layout information file 51, information on which part of the GUI, i.e., the print setting screen which setting screen for setting a function is displayed is written.

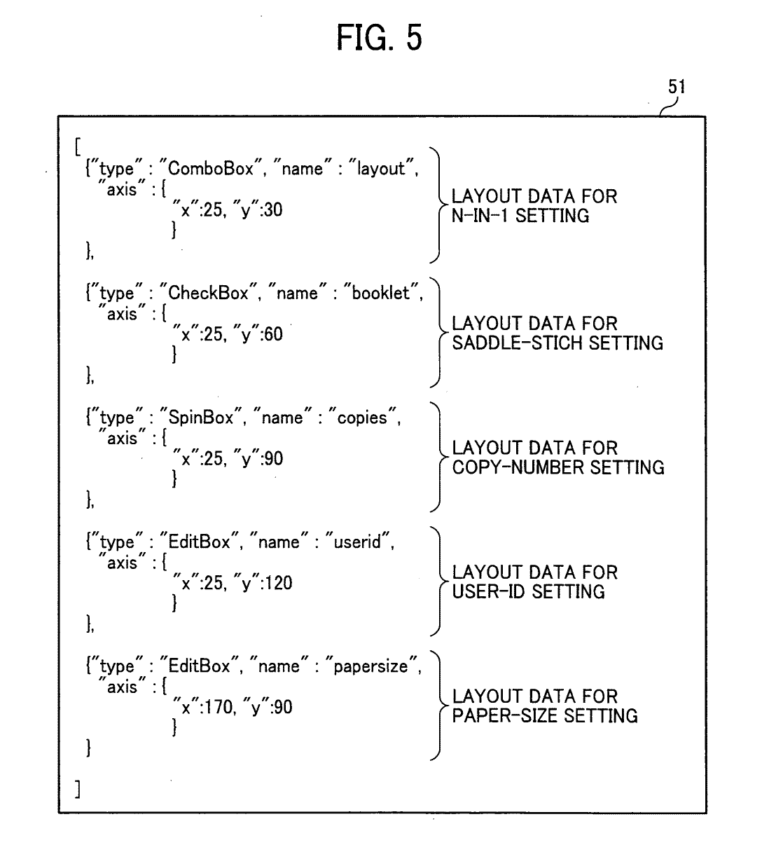

FIG. 5 shows an example of content of the screen-layout information file 51. In this example, the screen-layout information file 51 is written in the JSON (Java Script Object Notation: Java is a registered trademark) format. However, the format of the screen-layout information file 51 is not limited to this example; information in the screen-layout information file 51 can be written in other formats as long as the same content can be written in the other formats.

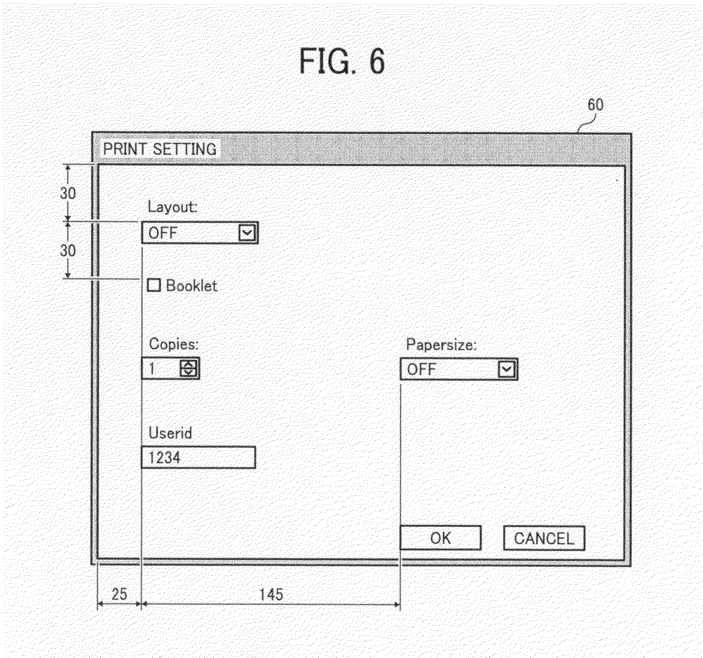

To return to the explanation of FIG. 5, the information written in the screen-layout information file 51 includes a type, a name, and coordinates of each setting unit for setting each function. As the coordinates, for example, coordinates of a start point of a setting unit on the print setting screen are written. In the example shown in FIG. 5, respective pieces of information on five functions for N in 1 setting, saddle stich setting, copy number setting, user ID setting, and paper size setting are written. FIG. 6 shows an example of a print setting screen 60 based on the description of the screen-layout information file 51. Based on the description of the screen-layout information file 51, respective setting screens for setting the form of N in 1 (Layout), with or without saddle stich (Booklet), the number of copies (Copies), a user ID (Userid), and the paper size (Papersize) are arranged and displayed in accordance with respective pieces of coordinate information according to respective types of the settings.

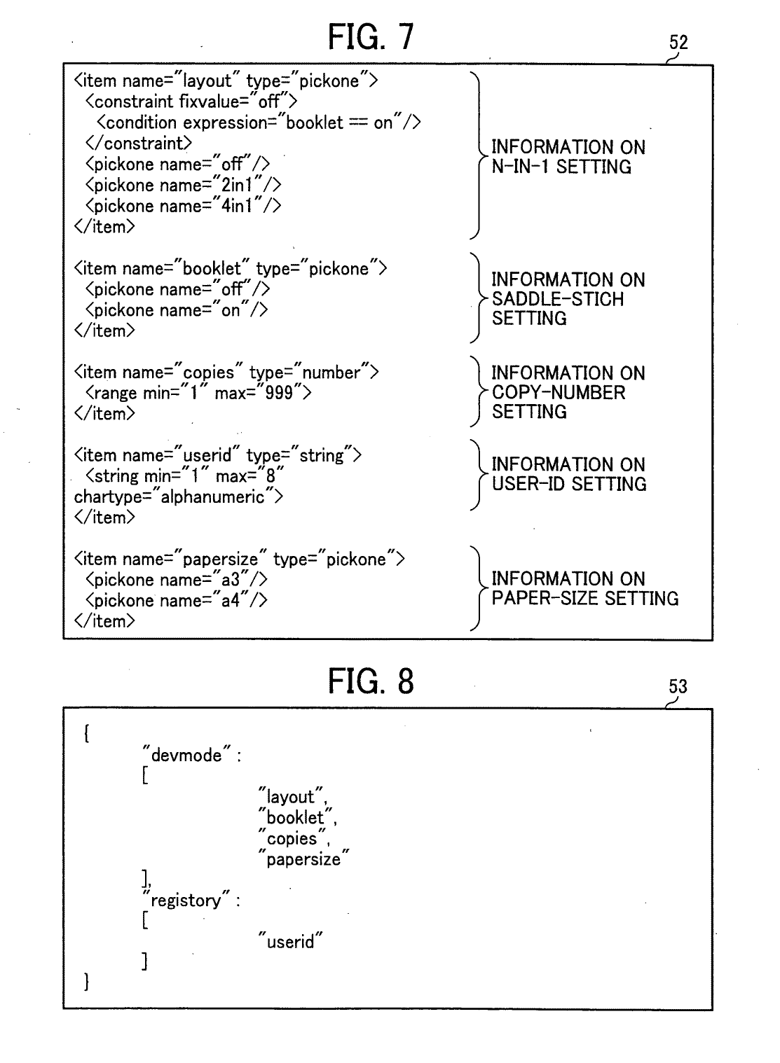

FIG. 7 shows an example of content of the function information file 52. In the function information file 52, details of the functions that the printer device 12 has are written. In this example, the function information file 52 is a text file written in the XML (Extensible Markup Language) format. However, the format of the function information file 52 is not limited to this example; information in the function information file 52 can be written in other formats as long as the same content can be written in the other formats.

In the example shown in FIG. 7, in the function information file 52, respective pieces of information on an N in 1 printing function, a saddle-stich printing function, a multiple-copies printing function (the number of copies), a user-ID setting function, and a paper-size setting function are written. As an example, as for the N-in-1 printing function, the following items are written.

Name of function: Layout

Type of function: pickone (function in the form of selection from choices)

List of choices: off/2 in¼in1

Exclusion information: Function is turned OFF if Booklet (the saddle-stich printing function) is turned ON

FIG. 8 shows an example of content of the setting-saving-destination information file 53. In this example, the setting-saving-destination information file 53 is written in the JSON format described above. However, the format of the setting-saving-destination information file 53 is not limited to this example; information in the setting-saving-destination information file 53 can be written in other formats as long as the same content can be written in the other formats.

In the setting-saving-destination information file 53, information on locations where respective set values of the functions set through the print setting screen 60 are saved is written. As the locations where the set values of the functions are saved, if the OS 21 is Windows (a registered trademark) developed by Microsoft Corporation USA, a Devmode structure and a registry which are provided by the OS 21 are generally used. Namely, in the setting-saving-destination information file 53, information on whether the Devmode structure or the registry to save each set value of each function set through the print setting screen 60 is written. In the example shown in FIG. 8, it is written that the respective pieces of setting information on the N in 1 printing function (layout), the saddle-stich printing function (booklet), the multiple-copies printing function (the number of copies: copies), and the paper size (papersize) are saved in the Devmode structure and the user ID information (userid) is saved in the registry.

Incidentally, although an illustration is omitted, in the same manner as the core module 30 described above, the plug-in module 40 also includes a module unit composed of an executable file, a library file, and the like and a driver setting information unit where driver setting information in the plug-in module 40 is saved. The module unit of the plug-in module 40 includes a drawing unit and a print setting unit in the same manner as in the core module 30. Depending on functions of the plug-in module 40, any of the drawing unit and the print setting unit can be omitted.

The driver setting information unit of the plug-in module 40 sets the operation of the plug-in module 40, and includes, for example, a screen-layout information file, a function information file, and a setting-saving-destination information file in the same manner as the core module 30 described above. Depending on functions of the plug-in module 40, any one or two of the screen-layout information file, the function information file, and the setting-saving-destination information file can be omitted.

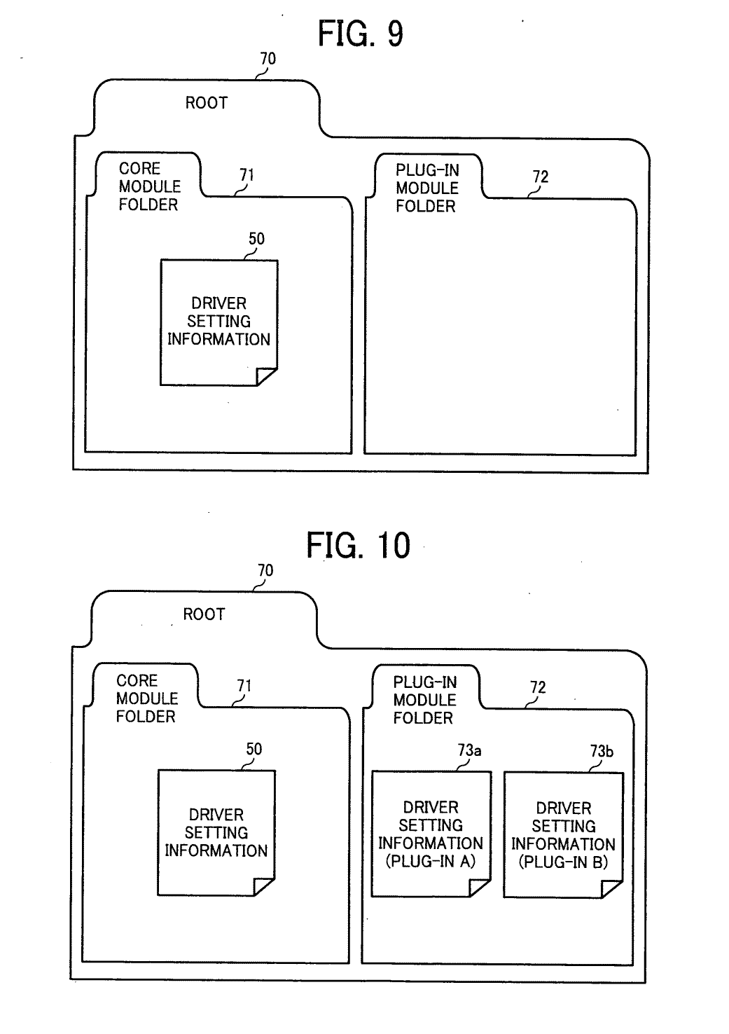

Subsequently, a management structure of an example of driver setting information according to the embodiment of the present invention is explained. In the present embodiment, the driver setting information 50 for the core module 30 and the driver setting information for the plug-in module 40 are managed independently of each other by using a folder structure. Namely, as illustrated in FIG. 9, a core module folder 71 for storing therein the driver setting information 50 for the core module 30 and a plug-in module folder 72 for storing therein the driver setting information for the plug-in module 40 are provided in a root folder 70.

As illustrated in FIG. 10, in the core module folder 71, a file of each piece of the driver setting information 50 of the core module 30 is stored. Furthermore, in the plug-in module folder 72, a file of each piece of the driver setting information of the plug-in module 40 is stored. In the example shown in FIG. 10, a file of driver setting information 73a of a plug-in A and a file of driver setting information 73b of a plug-in B are stored in the plug-in module folder 72.

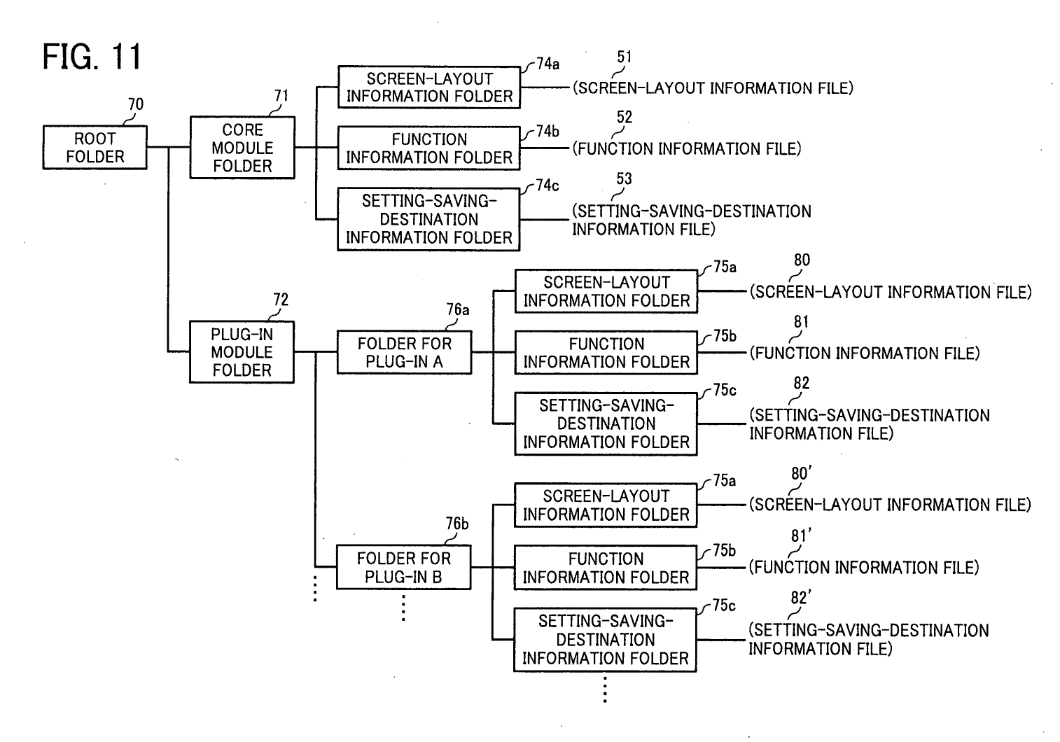

FIG. 11 shows an example of a more concrete management structure of the driver setting information according to the embodiment of the present invention. Under the root folder 70, the core module folder 71 and the plug-in module folder 72 are provided. Under the core module folder 71, a folder 74a for storing therein the screen-layout information file 51, a folder 74b for storing therein the function information file 52, and a folder 74c for storing therein the setting-saving-destination information file 53 are provided.

Under the plug-in module folder 72, folders 76a, 76b, . . . for storing the driver setting information of the plug-in module 40 are provided for each plug-in module. In this example, the folder 76a for storing therein the driver setting information 73a of the plug-in A and the folder 76b for storing therein the driver setting information 73b of the plug-in B are provided.

Each of the folders 76a, 76b, . . . has the same structure as the core module folder 71 described above. Namely, under each of the folders 76a, 76b, . . . , a folder 75a for storing therein a screen-layout information file, a folder 75b for storing therein a function information file, and a folder 75c for storing therein a setting-saving-destination information file are provided.

For example, in the folders 75a, 75b, and 75c provided under the folder 76a, a screen-layout information file 80, a function information file 81, and a setting-saving-destination information file 82 composing the driver setting information 73a of the plug-in A, respectively, are stored. Similarly, in the folders 75a, 75b, and 75c provided under the folder 76b, a screen-layout information file 80′, a function information file 81′, and a setting-saving-destination information file 82′ composing the driver setting information 73b of the plug-in B, respectively, are stored.

In this manner, the folder structure for storing the driver setting information 50 of the core module 30 is identical to the folder structure for storing the driver setting information of the plug-in module 40, whereby the driver setting information can be treated in the same manner between the core module 30 and the plug-in module 40, which makes it easy to manage the driver setting information.

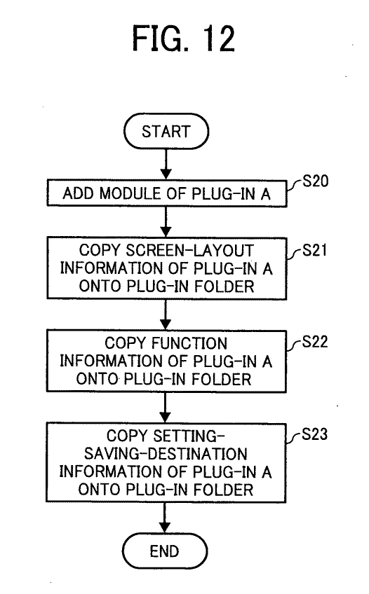

FIG. 12 is a flowchart illustrating a process of adding an example of a plug-in based on the management structure shown in FIG. 11. The addition of a plug-in to the printer driver 22 is made, for example, by copying each of files composing the plug-in module 40 onto a predetermined folder. It is thought that the process illustrated in FIG. 12 is executed, for example, by an installer provided together with a plug-in and dedicated to the plug-in. Here, it is explained that the plug-in A is added to the printer driver 22.

First, at Step S20, each of files composing the module unit in the plug-in module 40 of the plug-in A is copied, for example, onto a predetermined folder. At this time, to store respective pieces of the driver setting information of the plug-in A, the folder 76a is created under the plug-in module folder 72, and the folders 75a, 75b, and 75c for storing the pieces of the driver setting information, respectively, are created under the folder 76a.

At the next Step S21, the screen-layout information file 80 of the plug-in A is copied onto the folder 75a for the screen-layout information file 80 under the folder 76a where the driver setting information 73a of the plug-in A is stored. Then, the function information file 81 of the plug-in A is copied onto the folder 75b for the function information file 81 under the folder 76a where the driver setting information 73a of the plug-in A is stored (Step S22). Furthermore, the setting-saving-destination information file 82 of the plug-in A is copied onto the folder 75c for the setting-saving-destination information file 82 under the folder 76a where the driver setting information 73a of the plug-in A is stored (Step S23).

Incidentally, here, there is described that a folder is created for each piece of the driver setting information of the plug-in module 40, and the pieces of the driver setting information are stored in created respective folders; however, it is not limited to this example. For example, all the pieces of the driver setting information may be stored in one folder together.

Furthermore, the plug-in module 40 may be provided, for example, in such a manner that all files composing the plug-in module 40 are put into an archive file capable of storing therein a plurality of files and folders all together. As an example of such an archive file, there is a zip file. In this case, respective folders in which the pieces of the driver setting information are stored are created in the archive file in advance, and when a plug-in module 40 is added, the folders storing the driver setting information may be retrieved from the archive file, and copied onto the plug-in module folder 72. Also in this case, of course, the pieces of the driver setting information can be retrieved from the respective folders in the archive file, and stored in the above-mentioned folders 75a, 75b, and 75c, respectively.

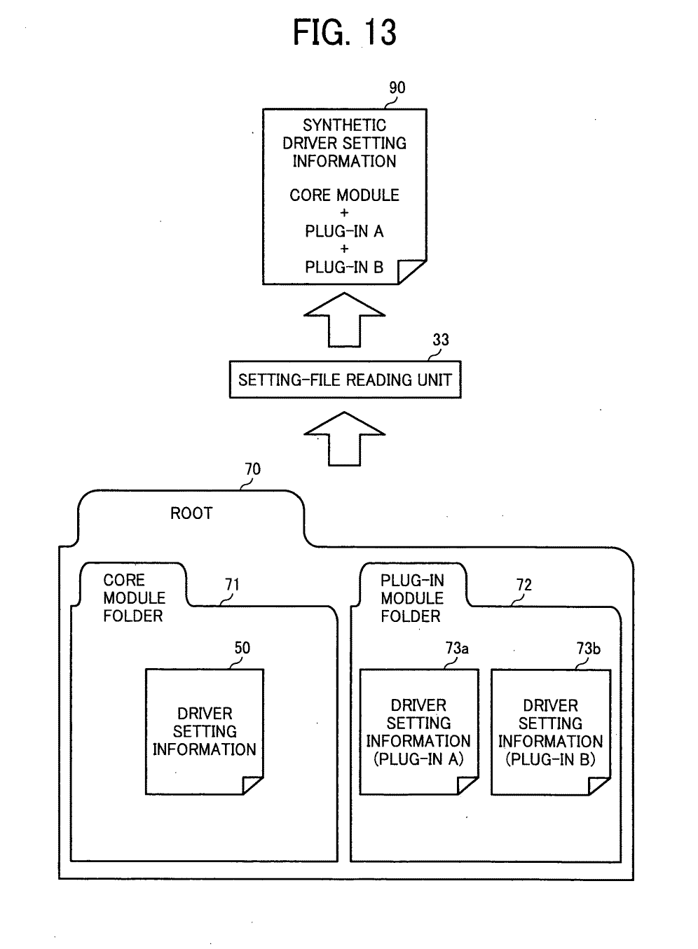

Subsequently, an example of a process of reading driver setting information of a plug-in according to the embodiment of the present invention is explained. In the present embodiment, as illustrated in FIG. 13, the setting-file reading unit 33 merges driver setting information of each plug-in (the driver setting information 73a and 73b in the example shown in FIG. 13) with the driver setting information 50 of the core module 30, and generates synthetic driver setting information 90.

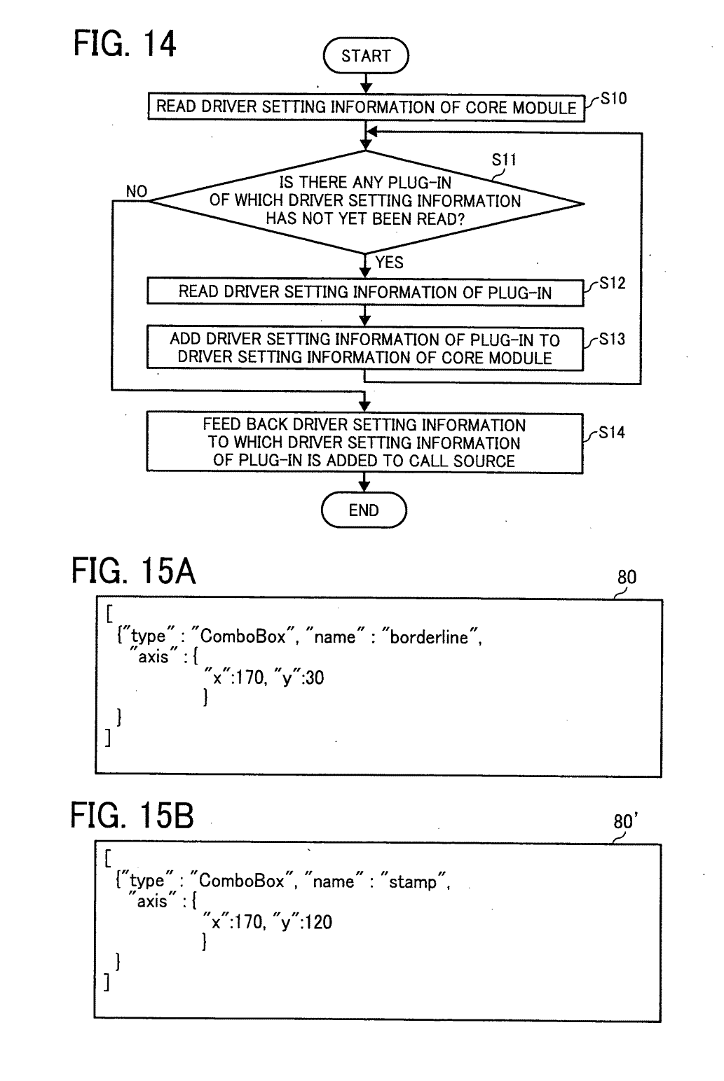

FIG. 14 is a flowchart illustrating a process of reading an example of driver setting information of a plug-in according to the present embodiment. The process according to the flowchart shown in FIG. 14 is executed by the setting-file reading unit 33. For example, at the start-up of the printer driver 22, the setting-file reading unit 33 reads the screen-layout information file 51, the function information file 52, and the setting-saving-destination information file 53, respectively, from the folders 74a, 74b, and 74c under the core module folder 71 (Step S10).

At the next Step S11, the setting-file reading unit 33 determines whether there is any plug-in of which the driver setting information has not yet been read out of plug-ins added to the printer driver 22. If the setting-file reading unit 33 determines that there is a plug-in of which the driver setting information has not yet been read, the process moves on to Step S12.

At Step S12, the setting-file reading unit 33 reads a screen-layout information file, a function information file, and a setting-saving-destination information file, respectively, from folders 75a, 75b, and 75c under a folder for the plug-in of which the driver setting information has not yet been read out of the folders 76a, 76b, . . . under the plug-in module folder 72.

As an example, it is assumed that plural plug-in modules, the plug-in A and the plug-in B, are added to the printer driver 22, and driver setting information of both the plug-ins has not yet been read. Furthermore, it is assumed that the driver setting information of the plug-in A is read first, and then the driver setting information of the plug-in B is read.

At Step S12, the setting-file reading unit 33 first reads the screen-layout information file 80, the function information file 81, and the setting-saving-destination information file 82, respectively, from the folders 75a, 75b, and 75c under the folder 76a where the driver setting information 73a of the plug-in A is stored.

Then, at the next Step S13, the setting-file reading unit 33 merges the respective pieces of the driver setting information of the plug-in read at Step S12 with the corresponding pieces of the driver setting information of the core module 30 read at Step S10.

In the example in which the driver setting information of the plug-in A is read at Step S12 described above, the setting-file reading unit 33 merges information written in the screen-layout information file 51 of the core module 30 with information written in the screen-layout information file 80 of the plug-in A. Furthermore, the setting-file reading unit 33 merges information written in the function information file 52 of the core module 30 with information written in the function information file 81 of the plug-in A. Likewise, the setting-file reading unit 33 merges information written in the setting-saving-destination information file 53 of the core module 30 with information written in the setting-saving-destination information file 82 of the plug-in A.

When the merging of the driver setting information of the plug-in at Step S13 is completed, the process returns to Step S11. In this example, the driver setting information of the plug-in B has not yet been read. Thus, the process moves on to Step S12, and the driver setting information of the plug-in B (the screen-layout information file 80′, the function information file 81′, and the setting-saving-destination information file 82′) is read. At the next Step S13, the driver setting information merged in the last process is further merged with the read driver setting information.

More specifically, the setting-file reading unit 33 merges data, which the information written in the screen-layout information file 51 of the core module 30 is merged with the information written in the screen-layout information file 80 of the plug-in A, with information written in the screen-layout information file 80′ of the plug-in B. Furthermore, the setting-file reading unit 33 merges data, which the information written in the function information file 52 of the core module 30 is merged with the information written in the function information file 81 of the plug-in A, with information written in the function information file 81′ of the plug-in B. Likewise, the setting-file reading unit 33 merges data, which the information written in the setting-saving-destination information file 53 of the core module 30 is merged with the information written in the setting-saving-destination information file 82 of the plug-in A, with information written in the setting-saving-destination information file 82′ of the plug-in B.

On the other hand, at Step S11, if it is determined that the driver setting information of all the plug-ins has been read, the process moves on to Step S14. At this point, the synthetic driver setting information 90, which the driver setting information of the core module 30 is merged with the driver setting information of all the plug-in modules 40 added to the printer driver 22, is generated. At Step S14, the setting-file reading unit 33 feeds back the pieces of the driver setting information composing the synthetic driver setting information 90 to respective call sources. The call sources are, for example, the application software 20, the OS 21, the core module 30 and the plug-in modules 40 of the printer driver 22, and the like.

The printer driver 22 controls the printer device 12 by using the synthetic driver setting information 90, and causes the printer device 12 to perform a predetermined print job. For example, in response to an instruction from the application software 20, the printer driver 22 controls a print job of the printer device 12 by calling the plug-in module 40 if necessary in accordance with the settings of the print setting screen 60 made on the basis of the synthetic driver setting information 90.

Incidentally, when to read the pieces of the driver setting information at Step S10 described above is not limited to the start-up of the printer driver 22. For example, when the plug-in module 40 is called by the printer driver 22 or the like, the driver setting information 50 of the core module 30 can be read at Step S10, and the pieces of the driver setting information of the called plug-in module 40 can be read at Step S11 or later.

A concrete example of the synthetic driver setting information 90 generated in the process illustrated in the flowchart in FIG. 14 is explained. Here, the above-mentioned plug-in A is described as a Borderline plug-in for drawing a frame border on each logical page in N in 1 printing, and the plug-in B is described as a Stamp plug-in for printing a specified stamp on a whole area of a document.

First, an example of driver setting information of each of the plug-in A (the Borderline plug-in) and the plug-in B (the Stamp plug-in) is explained more concretely. FIG. 15A shows an example of information written in the screen-layout information file 80 of the Borderline plug-in. FIG. 15B shows an example of information written in the screen-layout information file 80′ of the Stamp plug-in. In the same manner as the screen-layout information file 51 of the core module 30 described with reference to FIG. 5, in each of the screen-layout information files 80 and 80′, a type, a name, and coordinates of a setting unit for setting a function are written.

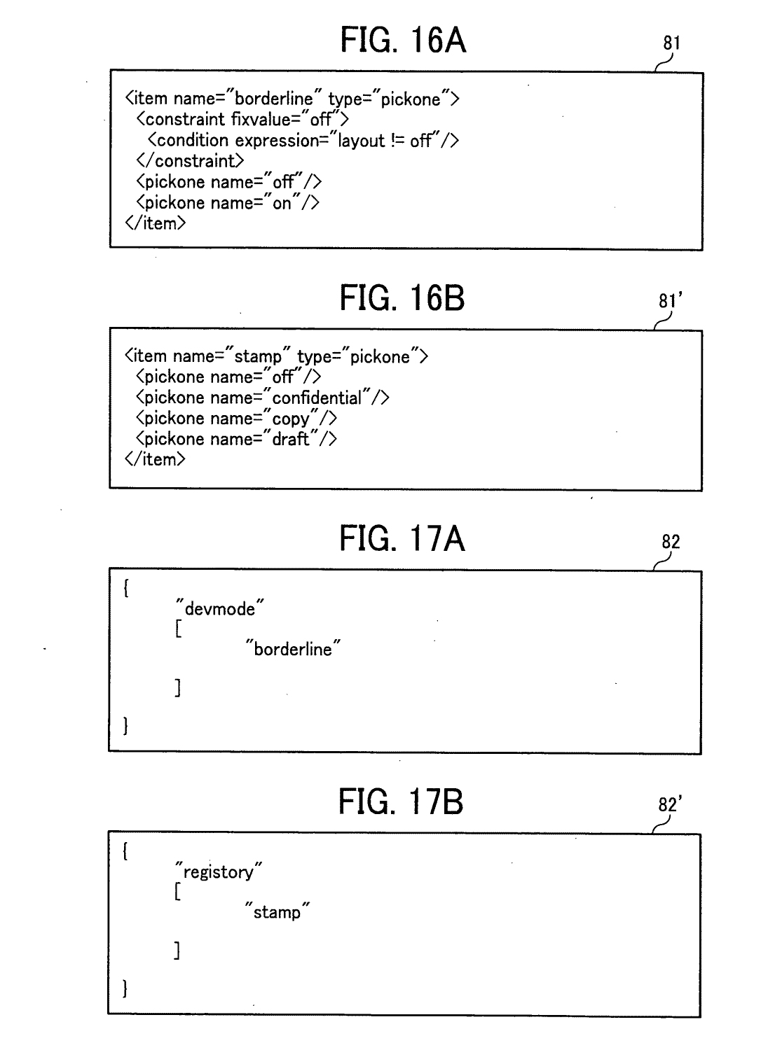

FIG. 16A shows an example of information written in the function information file 81 of the Borderline plug-in. FIG. 16B shows an example of information written in the function information file 81′ of the Stamp plug-in. In the same manner as the function information file 52 of the core module 30 described with reference to FIG. 7, in each of the function information files 81 and 81′, information on a function is written. Since the Borderline plug-in and the Stamp plug-in each have a single function only, in each of the examples shown in FIGS. 16A and 16B, only information on the single function is written.

For example, as for the Borderline plug-in, the following items are written in the function information file 81.

Name of function: borderline

Type of function: pickone

List of choices: off/on

Exclusion information: Function is turned OFF if N-in-1 is turned OFF

Furthermore, for example, as for the Stamp plug-in, the following items are written in the function information file 81′.

Name of function: stamp

Type of function: pickone

List of choices: off/confidential/copy/draft

Prohibition: Nothing

FIG. 17A shows an example of information written in the setting-saving-destination information file 82 of the Borderline plug-in. FIG. 17B shows an example of information written in the setting-saving-destination information file 82′ of the Stamp plug-in. In the setting-saving-destination information file 82, it is written that the setting information of the Borderline plug-in is saved in a Devmode structure. In the setting-saving-destination information file 82′, it is written that the setting information of the Stamp plug-in is saved in a registry.

Subsequently, the example where the driver setting information of the plug-in module 40 read by the setting-file reading unit 33 is merged with the driver setting information 50 of the core module 30 is explained more concretely.

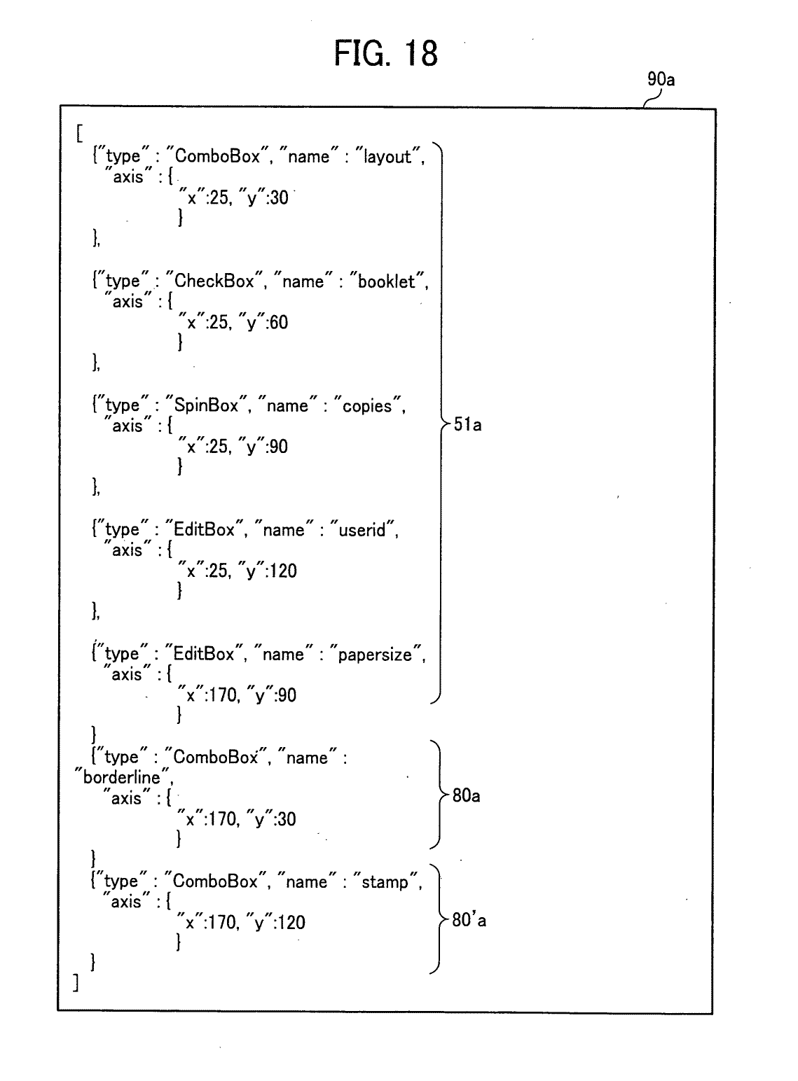

FIG. 18 shows an example where information written in the screen-layout information file 80 of the plug-in A and information written in the screen-layout information file 80′ of the plug-in B are merged with information written in the screen-layout information file 51 of the core module 30. Two pieces of screen-layout information 80a and 80′a written in the screen-layout information files 80 and 80′, respectively, are appended to screen-layout information 51a written in the screen-layout information file 51, and synthetic screen-layout information 90a is generated.

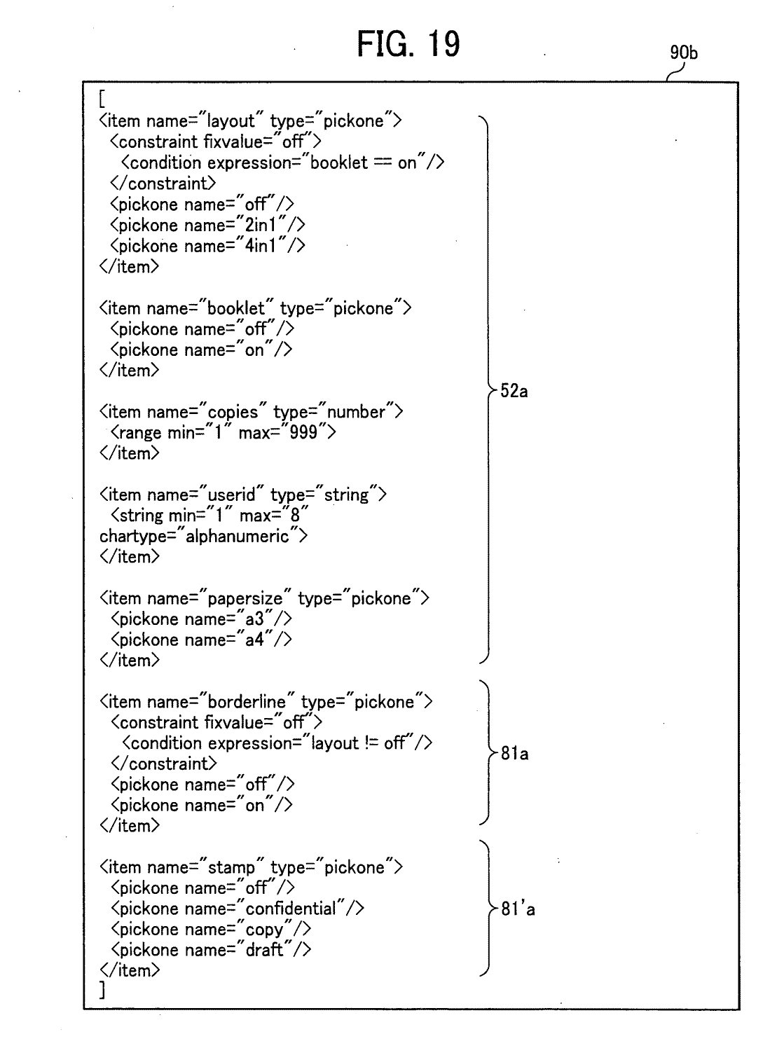

FIG. 19 shows an example where information written in the function information file 81 of the plug-in A and information written in the function information file 81′ of the plug-in B are merged with information written in the function information file 52 of the core module 30. Two pieces of function information 81a and 81′a written in the function information files 81 and 81′, respectively, are appended to function information 52a written in the function information file 52, and synthetic function information 90b is generated.

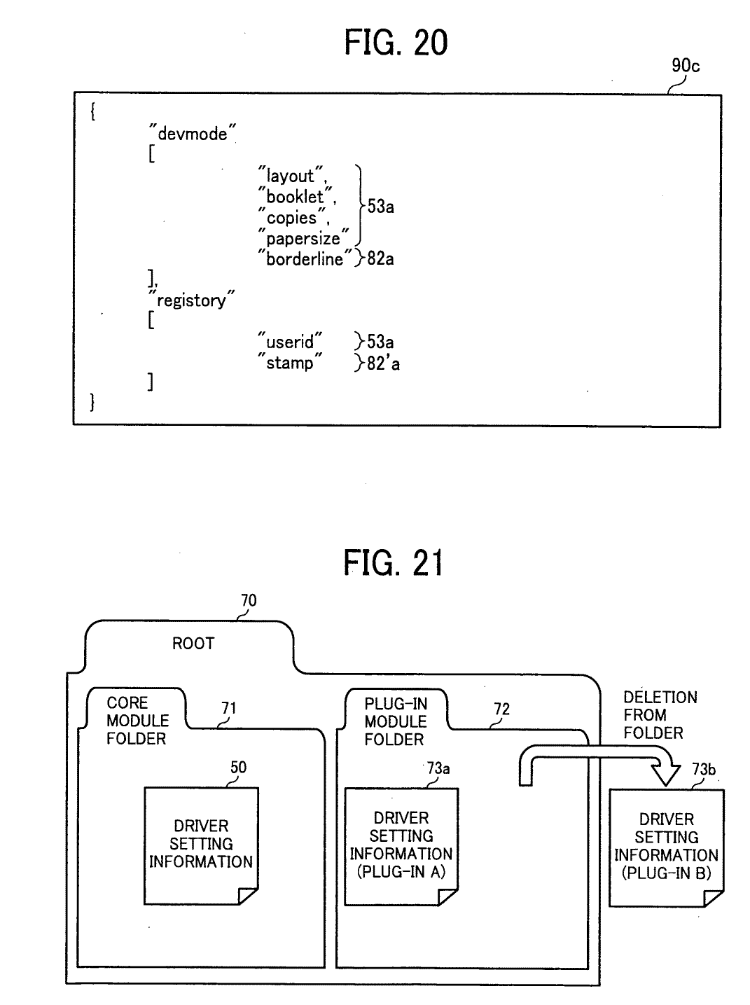

FIG. 20 shows an example where information written in the setting-saving-destination information file 82 of the plug-in A and information written in the setting-saving-destination information file 82′ of the plug-in B are merged with information written in the setting-saving-destination information file 53 of the core module 30. Two pieces of setting-saving-destination information 82a and 82′a written in the setting-saving-destination information files 82 and 82′, respectively, are appended to setting-saving-destination information 53a written in the setting-saving-destination information file 53, and synthetic setting-saving-destination information 90c is generated.

The synthetic screen-layout information 90a, the synthetic function information 90b, and the synthetic setting-saving-destination information 90c generated as described above are held, for example, in the RAM 103. However, the location to hold the synthetic screen-layout information 90a, the synthetic function information 90b, and the synthetic setting-saving-destination information 90c is not limited to the RAM 103; alternatively, the synthetic screen-layout information 90a, the synthetic function information 90b, and the synthetic setting-saving-destination information 90c can be stored in respective files, and the files can be held in the hard disk 105 or the like. The synthetic screen-layout information 90a, the synthetic function information 90b, and the synthetic setting-saving-destination information 90c are discarded, for example, when the printer driver 22 is terminated.

In the present embodiment, as described above, respective pieces of the driver setting information of the core module 30 and the plug-in module 40 are managed independently of each other. Furthermore, when a plurality of plug-in modules 40, 40, . . . , for example, like the plug-in A and the plug-in B, are added to the printer driver 22, respective pieces of driver setting information of the plurality of plug-in modules 40, 40, . . . are managed independently of one another. Thus, when an intended plug-in module 40 is removed from the printer driver 22, as illustrated in FIG. 21, it is only necessary to delete the driver setting information of the plug-in module 40 to be removed from the plug-in module folder 72.

FIG. 21 shows an example of a case where the plug-in B is removed from the printer driver 22 according to the embodiment of the present invention, and only the driver setting information 73b of the plug-in B is deleted from the plug-in module folder 72.

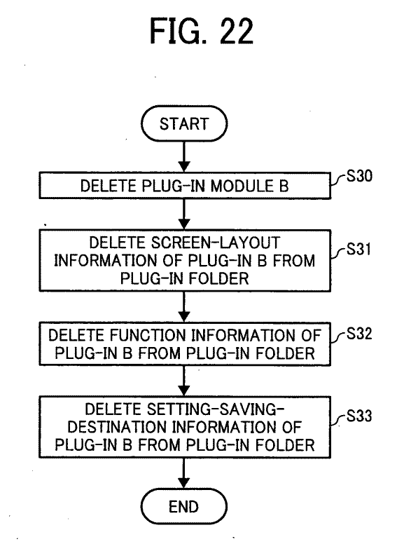

FIG. 22 is a flowchart illustrating a process of deleting an example of a plug-in. Here, the plug-in B will be deleted from the printer driver 22. The process illustrated in FIG. 22 is executed, for example, by an exclusive uninstaller for a plug-in to be deleted.

First, at Step S30, the plug-in module 40 of the plug-in B is deleted from the printer driver 22. For example, each of files composing the module unit in the plug-in module 40 of the plug-in B is deleted from the predetermined folder. Then, the screen-layout information file 80′ of the plug-in B is deleted from the folder 75a under the folder 76b where the driver setting information 73b of the plug-in B is stored (Step S31). Then, the function information file 81′ of the plug-in B is deleted from the folder 75b under the folder 76b (Step S32). Furthermore, the setting-saving-destination information file 82′ of the plug-in B is deleted from the folder 75c under the folder 76b (Step S33). Then, the empty folders 75a, 75b, and 75c are deleted, and further the folder 76b is deleted.

As described above, according to the present invention, in the printer driver 22, the driver setting information 50 of the core module 30 and the driver setting information of the plug-in module 40 added to the printer driver 22 are stored in different folders from each other, and managed independently of each other. For example, at the start-up of the printer driver or when the plug-in module is called, the driver setting information 50 of the core module 30 and the driver setting information of the plug-in module 40 are merged, and the merged driver setting information is used. Thus, a process of removing the plug-in module 40 from the printer driver 22 can be performed easily.

Incidentally, the printer driver and the plug-in software which are installed on the computer 11 according to the embodiment described above are each provided by being recorded on the computer-readable storage medium 110, such as a CD (Compact Disk), a flexible disk (FD), or a DVD (Digital Versatile Disk), in an installable or executable file format, and read from the storage medium 110 by the drive device 107, and then installed on the computer 11.

Furthermore, the printer driver and the plug-in software which are executed by the computer 11 according to the embodiment described above can be stored on a computer connected to a network, such as the Internet or a LAN, so that the printer driver and the plug-in software can be provided by being downloaded via the network. Moreover, the printer driver and the plug-in software which are executed by the computer 11 according to the present embodiment can be provided or distributed via a network such as the Internet.

The printer driver and the plug-in software which are executed by the computer 11 according to the embodiment described above are each read from the above-mentioned storage medium 110 and executed by the CPU 101, thereby being loaded on a main storage device (the RAM 103), and the printer driver and the plug-in software are generated on the main storage device.

According to the present invention, it is possible to achieve the effect that an extension added to a printer driver can be easily removed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A printer driver program product comprising a computer usable medium having computer readable program codes embodied in the medium that when executed causes a computer, which includes a storage unit storing therein first setting information for setting the operation of a basic function of a printer device and being capable of storing therein second setting information for setting the operation of an extension of extending the basic function independently of the first setting information, to execute:
reading the first setting information and the second setting information from the storage unit;
merging the first setting information and the second setting information which are read at the reading; and
controlling the printer device by using setting information which the first setting information and the second setting information are merged at the merging.

2. The printer driver program product according to claim 1, wherein
a file in which the first setting information is stored and a file in which the second setting information is stored are stored in different folders from each other, and the folders are stored in the storage unit, and
the reading includes reading the first setting information and the second setting information from the respective files stored in the different folders in the storage unit.

3. The printer driver program product according to claim 1, wherein
a plurality of extensions with respect to the basic function can be added, and a plurality of pieces of second setting information corresponding to the plurality of extensions are stored in the storage unit independently of one another, and
the reading includes reading the first setting information and the plurality of pieces of second setting information from the storage unit.

4. The printer driver program product according to claim 1, wherein
the first setting information and the second setting information each include a plurality of pieces of information corresponding to each other,
a plurality of files in which the plurality of pieces of information included in the first setting information are stored are stored in different folders from one another, and the folders are stored in the storage unit,
a plurality of files in which the plurality of pieces of information included in the second setting information are stored are stored in different folders from one another in the same configuration as the first setting information, and the folders are stored in the storage unit, and
the reading includes:
reading the plurality of pieces of information included in the first setting information from the plurality of files stored in the different folders stored in the storage unit; and
reading the plurality of pieces of information included in the second setting information from the plurality of files stored in the different folders stored in the storage unit.

5. The printer driver program product according to claim 4, wherein the merging includes merging each of the plurality of pieces of information included in the first setting information with corresponding one of the plurality of pieces of information included in the second setting information thereby generating a plurality of pieces of setting information corresponding to the plurality of pieces of information.

6. The printer driver program product according to claim 4, wherein the plurality of pieces of information includes function information indicating the basic function or the extension, screen-layout information indicating a layout of a setting screen for setting a function indicated in the function information, and setting-saving-destination information indicating a destination to save information set through the setting screen.

7. An information processing apparatus comprising:
a storage unit that stores therein first setting information for setting the operation of a basic function of a printer device, and is capable of storing therein second setting information for setting the operation of an extension of extending the basic function independently of the first setting information;
a reading unit that reads the first setting information and the second setting information from the storage unit;
a merging unit that merges the first setting information and the second setting information which are read by the reading unit; and
a control unit that controls the printer device by using setting information which the first setting information and the second setting information are merged by the merging unit.
